(19) United States
(12) Patent Application Publication
(10) Pub. No.: US 2017/0009714 A1
(43) Pub. Date: Jan. 12, 2017

(54) Offset Port Diverter Valve for Forced Induction Engines

(71) Applicant: Blitzkraft LLC, Denver, CO (US)

(72) Inventor: Andrew James Emanuel, Denver, CO (US)

(73) Assignee: BLITZKRAFT LLC, Denver, CO (US)

(21) Appl. No.: 14/794,759

(22) Filed: Jul. 8, 2015

(51) Int. Cl. F02M 35/10; F16K 1/38; F16K 1/12

(52) U.S. Cl. CPC F02M 35/10255; F16K 1/12; F16K 1/38

(57) ABSTRACT

A diverter valve consisting of a body, piston, operating mechanism, inlet port, and outlet port. The outlet port is arranged concentric to the center axis of the piston and body, while the inlet port is offset from the central axis. When signaled to open, the valve vents pressurized gas. The offset arrangement of the inlet port and the tapered shape of the piston create a swirl pattern in the gas flow which reduces turbulence and increases flow rate.

### BACKGROUND OF THE INVENTION

This invention improves the performance and emissions control of modern forced induction internal combustion engines. Forced induction has become a prevalent method for increasing the performance and fuel economy of modern engines while reducing emissions. This approach utilizes an external means of introducing intake air into the engine, typically via supercharging or turbo-supercharging. A device external to the principal workings of the engine compresses the intake air beyond atmospheric pressure in order to provide a higher mass of air for combustion than the engine would normally draw in of its own function.

Forced induction engines employing a throttle plate or similar airflow regulation device can create a destructive situation when this airflow control is suddenly closed. The volume of air between the compressor and the throttle plate contains energy in the form of flow and pressure. When the throttle plate is closed, this flow and pressure suddenly increase to levels that damage the compressor if left unmitigated. For this reason, all modern engines of this configuration employ a compressor bypass, or “diverter” valve to vent the compressed intake air safely away from this cavity. This allows the compressor to maintain inertia and avoid the damage caused by a dangerous pressure spike.

This invention is an improvement to the existing configurations of diverter valves currently employed. Typical valves are configured for basic functionality and manufacturing ease, while performance is not optimized. Modern engines utilize higher intake charge pressures and smaller volumetric capacities to meet power, efficiency, and emissions requirements. These higher pressures result in greater stress to diverter valves thereby increasing the risk to expensive compressor components. In order to meet the flow requirements, a conventional diverter valve will have to grow in size to adequately vent the surplus intake charge air.

This invention improves the mass flow capability and reaction time of the valve, without the expected increase in size. It is a direct replacement for conventional valves while offering significantly improved performance.

### BRIEF DESCRIPTION OF THE SEVERAL VIEWS OF THE DRAWING

FIG. 1 shows a schematic of the intake system of a forced induction internal combustion engine. The compressor 1 of the forced induction system compresses intake air from the low pressure intake passage 7 into the engine 2 through the throttle plate or other air metering device 3 via the high pressure intake passage 4. The diverter valve 5 communicates between high pressure intake passage 4 and low pressure intake system 7 via return passage 6.

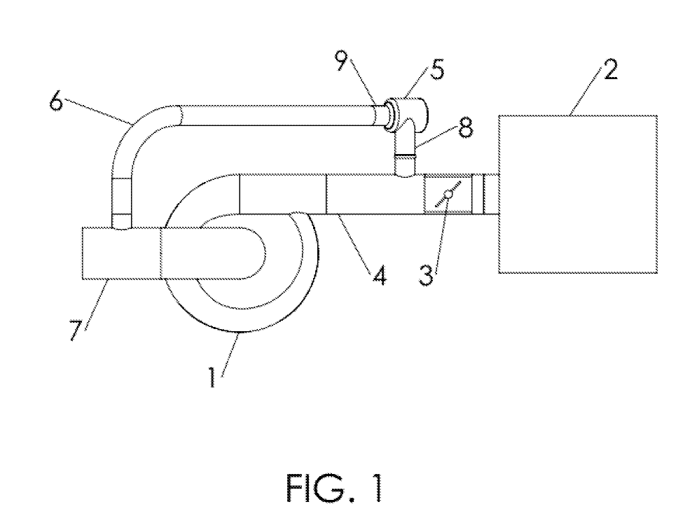

FIG. 2 is an exterior view of the invention. The inlet port 8 of the diverter valve 5 is open to the high pressure intake passage 4. The outlet port 9 of the diverter valve 5 is open to the return passage 6. The central axis of the inlet port 8 does not lie in the same plane with the central axis of the outlet port 9, instead it is substantially offset.

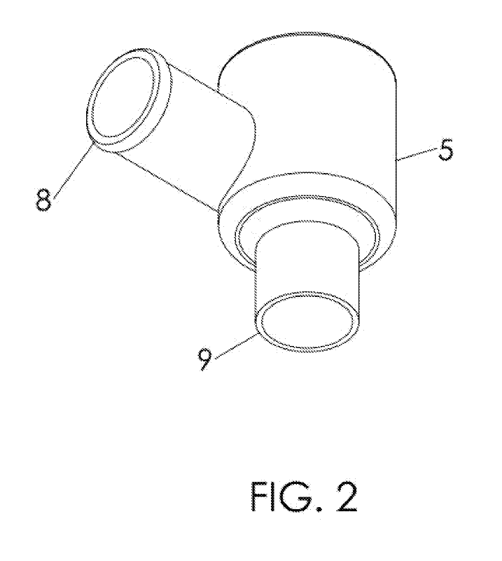

FIG. 3 is a cross sectional view of the invention with the valve shown in the closed position. The diverter valve 5 employs a substantially conical plunger 10 and a corresponding seat 11 to seal the valve under working pressure.

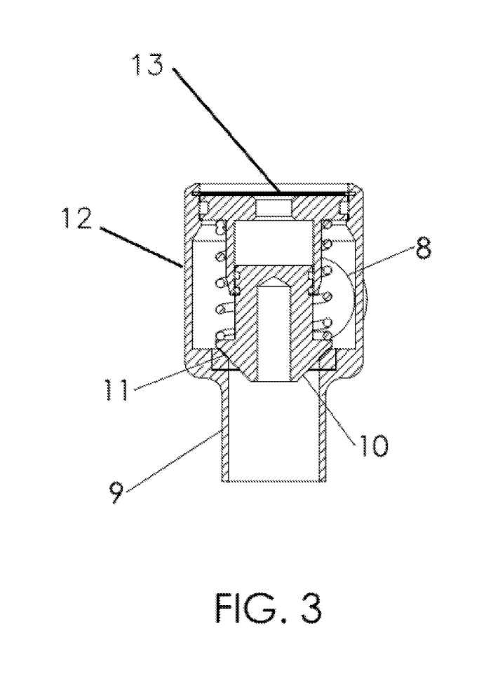

FIG. 4 is a cross sectional view of the invention with the valve shown in the open position. When signaled to open, the conical plunger 10 retracts from the seat 11 to open a passage between the inlet passage 4 and the intake return passage 6.

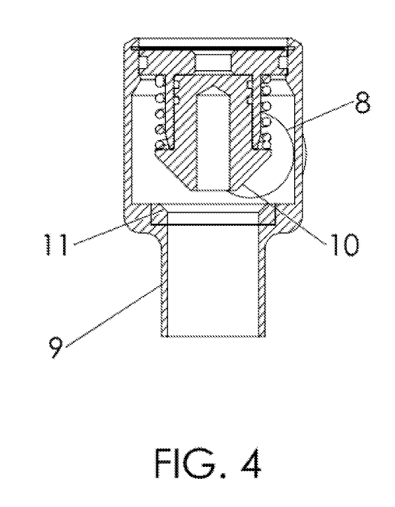

### DETAILED DESCRIPTION OF THE INVENTION

The diverter valve 5 is an ancillary component of a forced induction internal combustion engine 2. In such an engine, intake air is compressed above atmospheric gage pressure in order to introduce more oxygen to the combustion process. This higher oxygen content enables greater power output for a given engine displacement than a naturally aspirated engine which can only ingest air at atmospheric pressure. A compressor device such as a turbocharger or turbo-supercharger 1 is employed to increase intake pressure. The diverter valve 5 is situated between the low pressure intake system 7 upstream of the compressor and the high pressure intake passage 4 downstream of the compressor 1 and communicates between them when required.

This diverter valve consists of several components: the body 12, the inlet port 8, the outlet port 9, the plunger 10, the valve seat 11 and the actuation mechanism 13. The actuation mechanism can be any means of opening and closing the valve; pneumatic, electro-mechanical, hydraulic or otherwise.

The primary function of the diverter valve is to vent intake charge pressure from the high pressure intake passage 4 on the downstream side of the compressor 1 to the low pressure intake system 7 on the upstream side. This event is typically required when the throttle plate 3 of the engine 2 is closed or substantially constricted. When gas flow into the engine 2 is thusly reduced, pressure quickly builds in the high pressure passage 4 due to the compressor 1 acting on a closed or substantially constricted fluid volume. This pressure surge creates negative side effects ranging from compressor 1 inertia reduction to damage in extreme cases. The diverter valve 5 allows pressurized gas to vent harmlessly into the low pressure intake system 7 and maintain compressor 1 inertia.

A secondary function of the diverter valve 5 is to allow intake air to bypass the compressor 1 at low flow conditions, such as when the engine 2 is accelerating from idle RPM. In this scenario, the engine's demand for air is restricted by the compressor 1. If the diverter valve 5 is opened, the intake air can bypass the slow moving compressor 1 until mass flow through the engine 2 is sufficient to accelerate the compressor to its operational state.

Due to increasing intake charge pressures and decreasing packaging opportunities in modern forced induction systems, a valve having superior mass flow capability in a small package is advantageous. This invention improves mass flow performance over existing implementations of similar dimensions by promoting laminar fluid flow in a spiraling motion between the inlet port 8 and outlet port 9 of the valve body. Two features of the design maintain this spiral flow pattern: the offset of the inlet port 8 axis relative to the central axis of the valve body 12, and the conical shape of the valve plunger 10. When open, this arrangement forms a passage shape that encourages laminar flow at higher mass flow rates relative to existing designs.

What is claimed is:

1. A forced induction diverter valve comprised of a body, inlet port, outlet port, plunger, and seat wherein the central axes of the inlet port and outlet port are arranged offset from one another and do not intersect.

2. A forced induction diverter valve having a conical plunger which operates concentric with the outlet port and valve seat.
